(19) United States
(12) Patent Application Publication
(10) Pub. No.: US 2007/0290472 A1
(43) Pub. Date: Dec. 20, 2007

(54) STEERING SHAFT ASSEMBLY CONNECTION

(75) Inventor: Kevin J. Audibert, Wolcott, CT (US)

Correspondence Address: MICHAEL BEST & FRIEDRICH LLP, 100 E WISCONSIN AVENUE, Suite 3300, MILWAUKEE, WI, 53202, US

(73) Assignee: TIMKEN US CORPORATION, Torrington, CT (US)

(21) Appl. No.: 11/421,499

(22) Filed: Jun. 1, 2006

(51) Int. Cl. B60G 7/00

(52) U.S. Cl. 280/93.502

(57) ABSTRACT

A steering assembly includes a steering shaft assembly having an end and a rack-and-pinion mechanism including a pinion assembly coupled to the end of the steering shaft assembly. The pinion assembly includes a bore extending between a first end of the pinion assembly and a second end of the pinion assembly. A fastener secures the end of the steering shaft assembly to the pinion assembly such that at least one of the end of the steering shaft assembly and the fastener is at least partially received within the bore in the pinion assembly.

### BACKGROUND

The present invention relates to steering assemblies for vehicles.

Vehicle steering systems typically include a steering shaft assembly operable based on driver input at one end from the steering wheel. The other end of the steering shaft assembly is typically connected to a rack-and-pinion mechanism to convey the rotational input of the steering wheel to directional movement of the wheels. Some systems include a power assist device coupled with the steering shaft assembly at a location spaced from the rack-and-pinion mechanism. With this type of system, the rack is known as a manual rack because it does not incorporate integral hydraulic or other types of power assist devices.

FIGS. 1-3 illustrate a prior art steering assembly. The steering shaft assembly 10 includes a first end 12 for connection to a vehicle's steering wheel, and a second end 14 connected to a manual rack-and-pinion mechanism 16. A conventional electrical power assist unit 18 is positioned between the first and second ends 12, 14 and includes an electric motor 20, a gear box 22, a circuit board 24, and a wire connection 26 between the circuit board 24 and the motor 20.

The steering shaft assembly 10 further includes an intermediate shaft assembly 28 having a lower connection end 30. The lower connection end 30 includes a conventional yoke and universal joint connection including a clamp yoke 32 that is secured to the pinion 34 of the rack-and-pinion mechanism 16. The end of the clamp yoke 32 must be aligned with and fit over the end of the pinion 34. Then, the bolt 36 must be tightened to secure the clamp yoke 32 onto the end of the pinion 34.

Interconnection of the components of a steering shaft assembly to each other and to the rack-and-pinion mechanism is often difficult due to the space and accessibility constraints present in the vehicle. In the prior art assembly shown in FIGS. 1-3, there can be difficulty in securing the clamp yoke 32 to the pinion 34. The assembler must access the yoke 32 and pinion 34 from underneath the vehicle or inside the vehicle (e.g., through the dash panel), perhaps even without the ability to see the yoke 32, the pinion 34, and the bolt 36. Aligning and interconnecting the parts, and tightening the bolt 36 are problematic.

### SUMMARY

The present invention provides an improved connection configuration and method for interconnecting a steering shaft assembly to the rack-and-pinion mechanism.

In one embodiment, the invention provides a steering assembly having a steering shaft assembly including an end, and a rack-and-pinion mechanism including a pinion assembly coupled to the end of the steering shaft assembly. The pinion assembly includes a bore extending between a first end of the pinion assembly and a second end of the pinion assembly. A fastener secures the end of the steering shaft assembly to the pinion assembly such that at least one of the end of the steering shaft assembly and the fastener is at least partially received within the bore in the pinion assembly.

In another embodiment the invention provides a method of connecting a steering shaft assembly to a pinion assembly of a rack-and-pinion mechanism. The steering shaft assembly includes an end. The pinion assembly includes a first end for receiving the end of the steering shaft assembly and a second end opposite the first end. The method includes positioning the end of the steering shaft assembly to be received by the first end of the pinion assembly, and securing the end of the steering shaft assembly relative to the pinion assembly using a fastener that is secured from the second end of the pinion assembly.

Other aspects of the invention will become apparent by consideration of the detailed description and accompanying drawings.

### BRIEF DESCRIPTION OF THE DRAWINGS

FIG. 1 is a front perspective view of a prior art steering assembly.

FIG. 2 is a side perspective view of the prior art steering assembly of FIG. 1.

FIG. 3 is an enlarged perspective view of the prior art steering assembly of FIG. 1 illustrating the connection between the intermediate shaft assembly and the pinion of the rack-and-pinion mechanism.

FIG. 4 is a front perspective view of a steering assembly embodying the invention.

FIG. 5 is an exploded perspective view, partially cut away, of a connection between the steering shaft assembly and the rack-and-pinion mechanism in the steering assembly of FIG. 4.

FIG. 6 is an enlarged view of FIG. 5.

FIG. 7 is an exploded perspective view, partially cut away, of another embodiment similar to that shown in FIG. 5 but where the shaft assembly functions as the pinion of the rack-and-pinion mechanism.

FIG. 8 is an enlarged view of FIG. 7.

FIG. 9 is another embodiment of a connection between a steering shaft assembly and a rack-and-pinion mechanism embodying the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

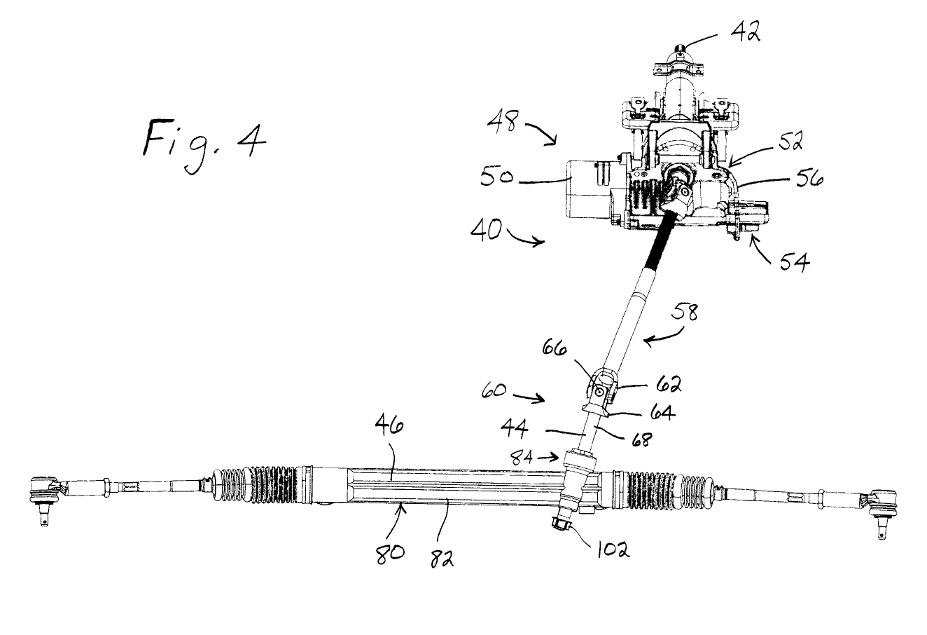

FIGS. 4-6 illustrate a first embodiment of the steering assembly of the present invention. The steering shaft assembly 40 includes a first end 42 for connection to a vehicle's steering wheel, and a second end 44 connected to a manual rack-and-pinion mechanism 46. A power assist unit 48 is positioned between the first and second ends 42, 44 and includes an electric motor 50, a gear box 52, a circuit board 54, and a wire connection 56 between the circuit board 54 and the motor 50.

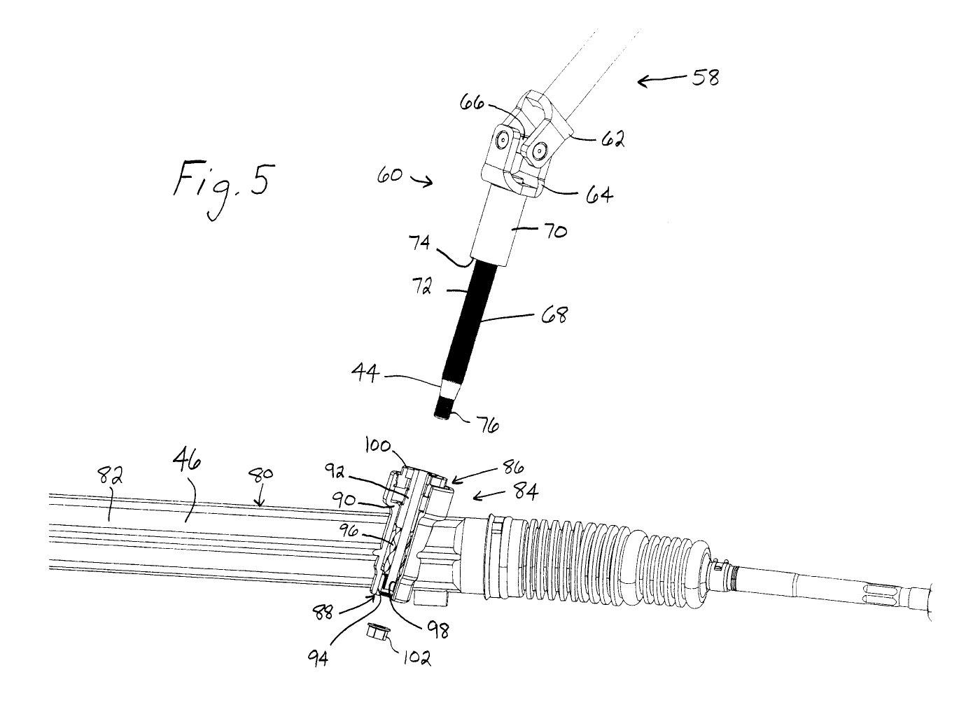

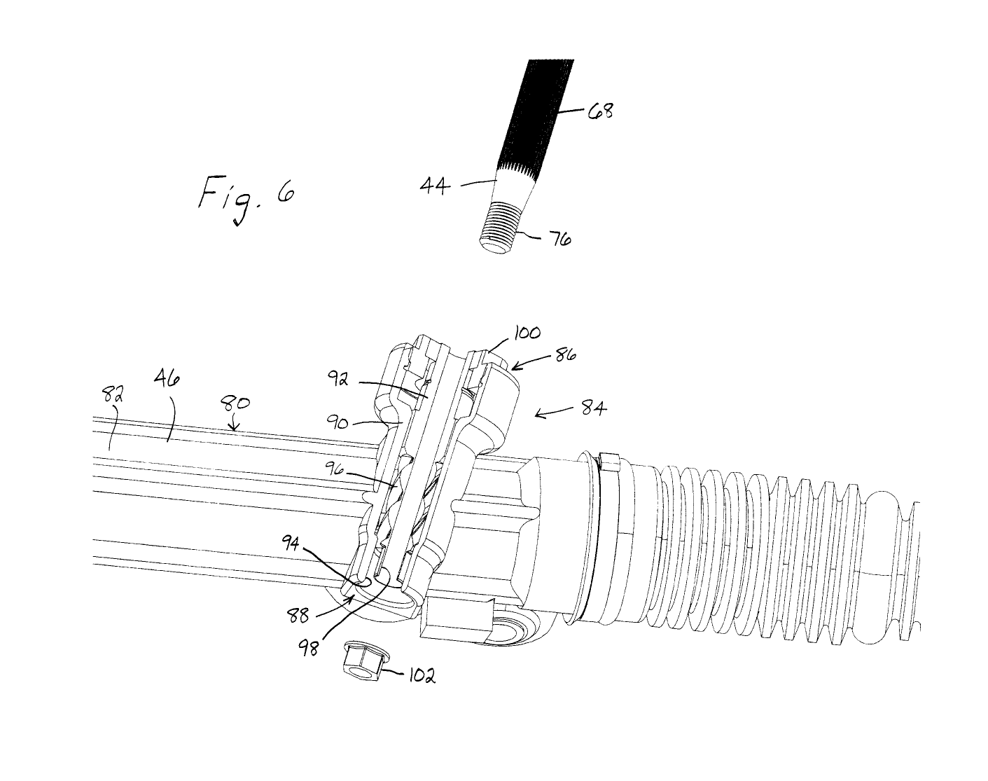

The steering shaft assembly 40 further includes an intermediate shaft assembly 58 having a lower connection end 60 that defines the second end 44 of the steering shaft assembly 40. As shown in FIGS. 4 and 5, the lower connection end 60 includes first and second yokes 62, 64, respectively, interconnected by a universal joint 66. The lower connection end 60 further includes a shaft 68 coupled to the yoke 64. The illustrated shaft 68 includes a large diameter portion 70 and a small diameter portion 72 separated by a shoulder 74. As best shown in FIG. 6, the illustrated small diameter portion 72 is splined and includes a threaded portion 76 at its distal end.

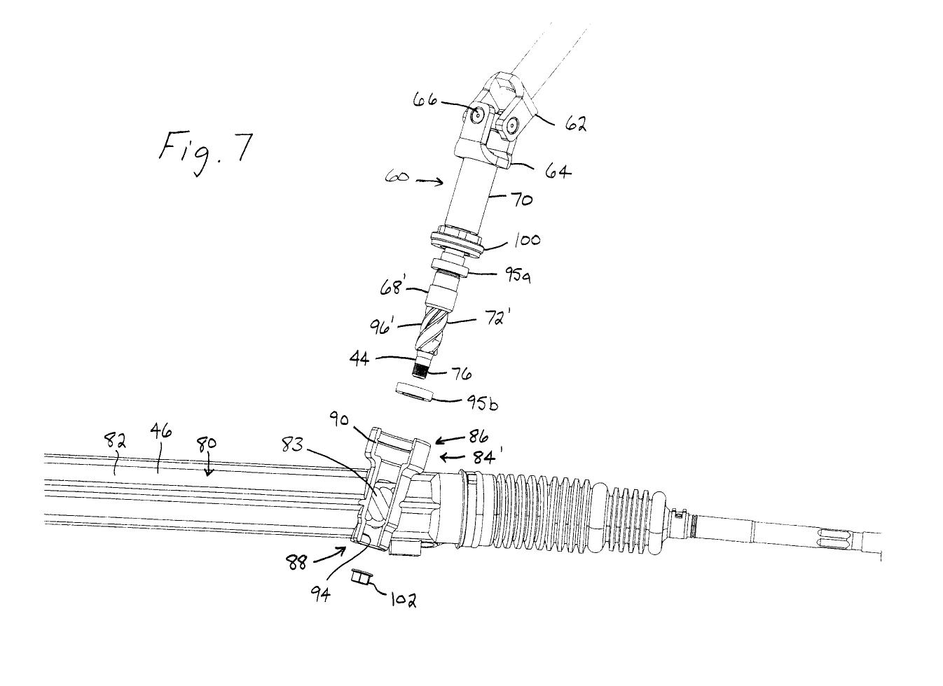

The manual rack-and-pinion mechanism 46 includes a rack assembly 80 including a rack housing 82 and a rack 83 (not shown in FIGS. 4-6, but see FIG. 7) inside the rack housing 82. As best seen in FIGS. 5 and 6, a pinion assembly 84 having a first end 86 and a second end 88 is coupled to the rack housing 82, and in the illustrated embodiment, includes a pinion housing or sleeve 90 integrally formed with the rack housing 82. In other embodiments, the rack housing 82 and the pinion housing 90 can be separate parts coupled together. The pinion assembly 84 further includes a pinion 92 housed in a bore 94 defined in the pinion housing 90 and that extends from the first end 86 to the second end 88. The pinion 92 is supported in the bore 94 by a bearing 95a near the first end 86 and a bearing 95b near the second end 88. The bearings are not shown for clarity in FIGS. 5 and 6, but can be seen in FIG. 7. The pinion 92 includes an outer surface including helical teeth 96 configured to mesh with the rack 83 and operate the rack-and-pinion mechanism 46, as is understood by those skilled in the art. The pinion 92 further includes a splined bore 98 extending therethrough between the first and second ends 86, 88 of the pinion assembly 84. The splines in the bore 98 are not shown for clarity in the figures. The illustrated pinion assembly 84 further includes a seal 100 positioned between the pinion 92 and the pinion housing 90 adjacent the first end 86 of the pinion assembly 84. The seal 100 helps prevent debris from entering the pinion assembly 84.

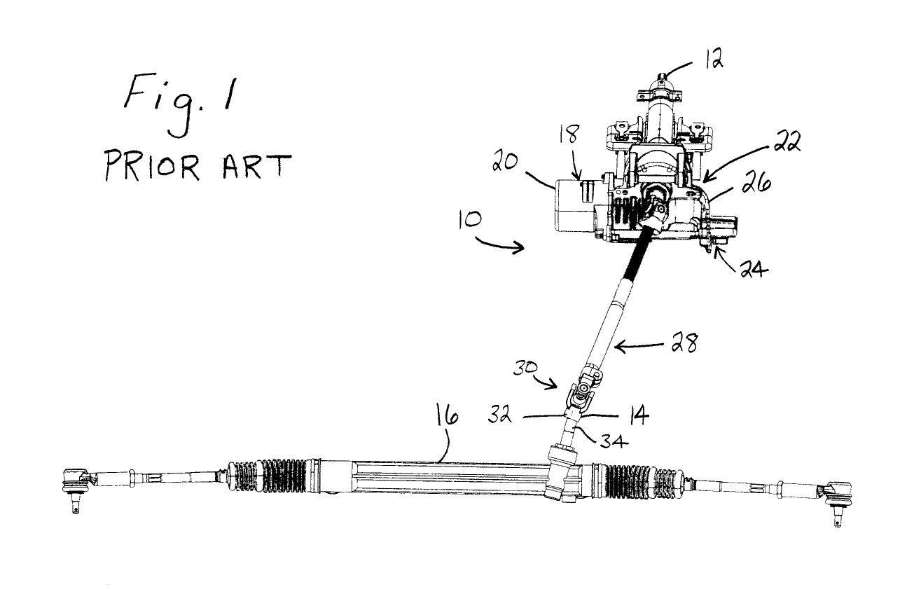

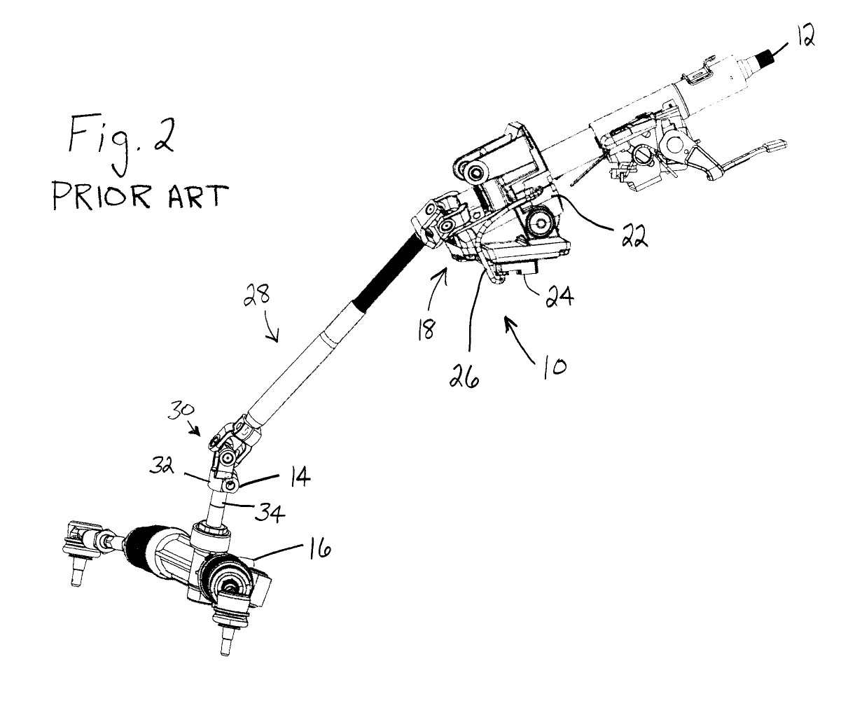

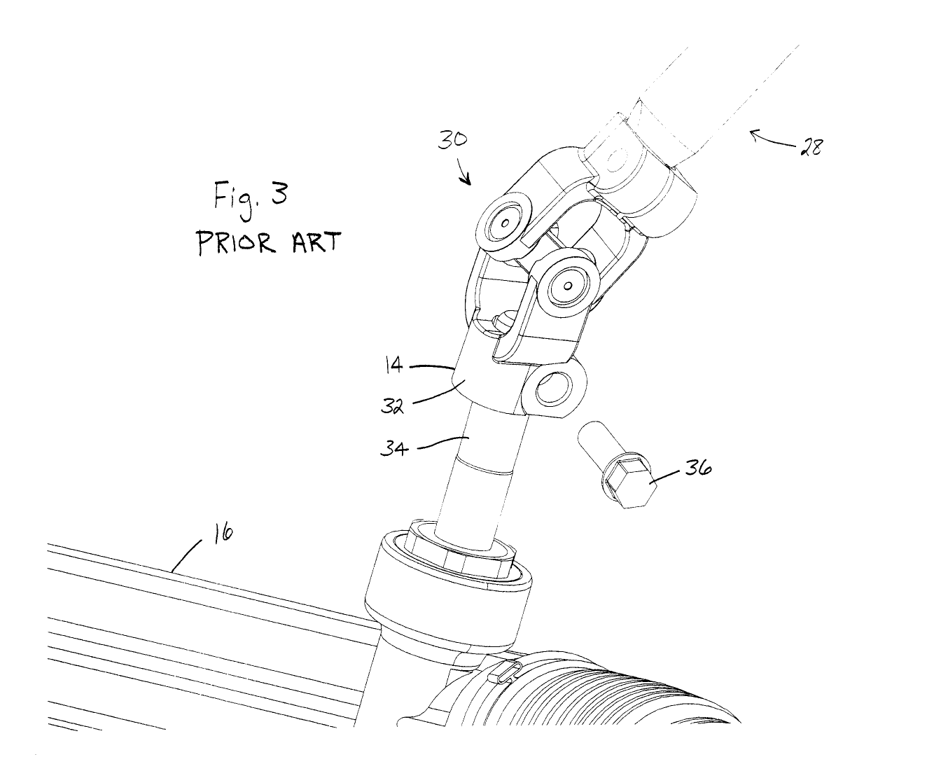

Interconnection of the steering shaft assembly 40 to the rack-and-pinion mechanism 46, and more particularly to the pinion assembly 84 is simplified in comparison to the interconnection between the prior art steering shaft assembly 10 and rack-and-pinion mechanism 16 illustrated in FIGS. 1-3. First, the shaft 68 is received by or inserted into the first end 86 of the pinion assembly 84, and more specifically into the bore 98 in the pinion 92. The splines on the small diameter portion 72 of the shaft mate with the splined bore 98 of the pinion 92 such that torque can be transmitted from the shaft 68 to the pinion 92. In other embodiments, the splines can be replaced with other devices or geometry capable of transmitting torque between the shaft 68 and the pinion 92. The shaft 68 is inserted into the bore 98 until the shoulder 74 abuts the seal 100 to effect a positive stop. When the shaft 68 is fully inserted, the threaded portion 76 of the shaft 68 extends at least partially out of the bore 98 from the second end 88 of the pinion assembly 84.

Next, a fastener in the form of a nut 102 is threaded onto the threaded portion 76 of the shaft 68 to secure the shaft 68 from being withdrawn from the bore 98, thereby securing the lower connection end 60 of the steering shaft assembly 40 to the pinion assembly 84. Due to the splined engagement between the shaft 68 and the pinion 92, the nut 102 can be tightened without the need to manually secure or prevent rotation of the shaft 68 adjacent the first end 86 of the pinion assembly 84 as the nut is being tightened. Therefore, access to the first end 86 of the pinion assembly 84 is not required to secure the nut 102 on the shaft 68, and thereby to secure the steering shaft assembly 40 to the rack-and-pinion mechanism 46.

This arrangement is particularly useful to facilitate assembly into the vehicle in light of the confined spaces and lack of access available in the portion of the vehicle containing these components. Specifically, while the first end 86 of the pinion assembly 84 is difficult to access, the second end 88 of the pinion assembly 84 is visible and accessible from the underside of the vehicle. The ability to secure the connection between the steering shaft assembly 40 and the rack-and-pinion mechanism 46 from the second end 88 of the pinion assembly 84 (i.e., from the accessible underside of the vehicle) will reduce assembly time, and therefore assembly cost.

Additionally, this arrangement can provide better axial alignment between the steering shaft assembly 40 and the pinion assembly 84 than was previously possible using the clamp yoke arrangement described with respect to FIGS. 1-3. Additionally, a reduction in runout can be achieved versus the prior art clamp yoke arrangement.

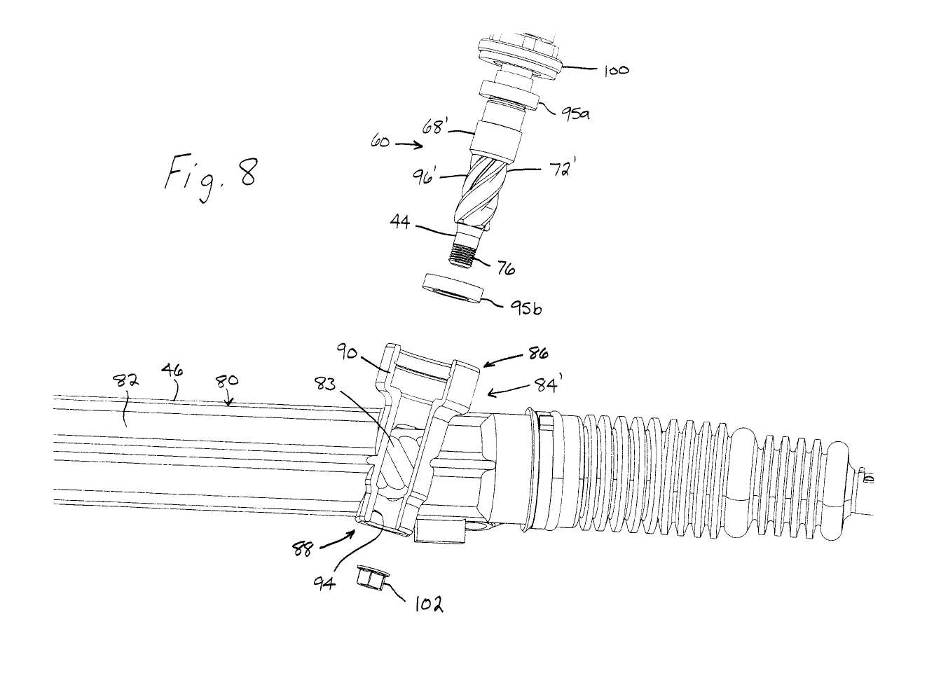

FIGS. 7 and 8 illustrate another embodiment of the steering shaft assembly and its interconnection to a rack-and-pinion mechanism. The connection method is similar to that described above for the embodiment shown in FIGS. 4-6, with some significant differences. Like parts have been given like reference numerals and will not be discussed again herein in detail, while modified parts have been designated as prime (′). Only the differences will be described in detail.

Referring to FIGS. 7 and 8, the pinion assembly 84′ does not include any pinion 92. Instead, the small diameter portion 72′ of the shaft 68′ has an outer surface including helical teeth 96′ configured to mesh with the rack 83 to operate the rack-and-pinion mechanism 46′. With this embodiment, the pinion 92 can be eliminated because its functionality is incorporated into the small diameter portion 72′ of the shaft 68′.

Assembly of the shaft 68′ to the pinion assembly 84′ occurs in substantially the same manner described above with respect to the embodiment shown in FIGS. 4-6 except that the shaft 68′ is inserted into the bore 94 formed in the pinion housing 90 instead of through a bore in a pinion. To accommodate the intermeshing of the helical teeth 96′ on the shaft 68′ with the rack 83, some rotation of the shaft 68′ or the rack 83 may be needed in order to insert the shaft 68′ into the bore 94.

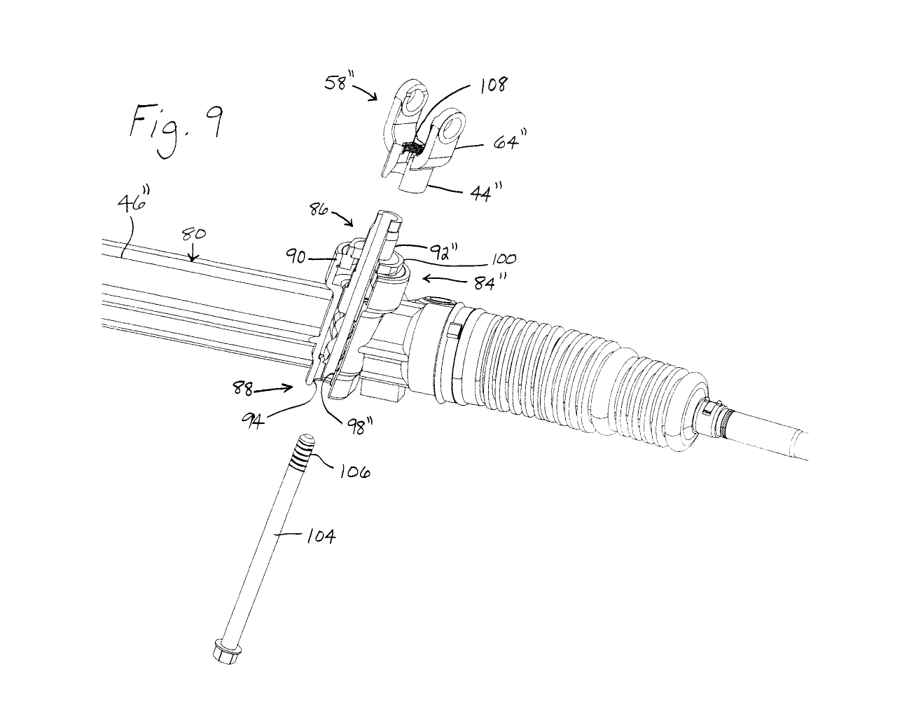

FIG. 9 illustrates another embodiment of the invention with an alternative securement method between the steering shaft assembly and the rack-and-pinion mechanism. Again, like parts have been given like reference numerals and will not be discussed again herein in detail, while modified parts have been designated as double prime (″). Only the differences will be described in detail.

In the embodiment illustrated in FIG. 9, the yoke 64″ is the distal end of the intermediate shaft assembly 58″, and therefore the end 44″ of the steering shaft assembly. There is no shaft extending from the yoke 64″ toward the pinion assembly 84″. Rather, the pinion 92″ of the pinion assembly 84″ extends from the first end 86 of the pinion housing 90 such that the pinion 92″ directly receives the yoke 64″ at the first end 86 of the pinion assembly 84″. In the illustrated embodiment, the pinion 92″ is formed with a double-D shaped outer surface and an adjacent tapered surface at its distal end for receiving a corresponding inner surface of the yoke 64″. This engagement at the interface prevents relative rotation between the yoke 64″ and the pinion 92″ such that rotation of the yoke 64″ transfers torque to the pinion 92″. In other embodiments, other mechanisms and geometries can be used to create the torque transfer relationship between the yoke 64″ and the pinion 92″.

To secure the yoke 64″ onto the pinion 92″, and therefore to the pinion assembly 84″, a fastener in the form of a bolt 104 is inserted into the bore 98″ in the pinion 92″ from the second end 88 of the pinion assembly 84″. The bolt has a threaded portion 106 that engages with threads 108 formed in the yoke 64″ to secure the yoke 64″ to the pinion assembly 84″. Due to the torque transmitting or anti-rotational engagement between the yoke 64″ and the double-D shaped outer surface of the pinion 92″, the bolt 104 can be tightened without the need to manually secure or prevent rotation of the yoke 64″ adjacent the first end 86 of the pinion assembly 84″. Therefore, access to the first end 86 of the pinion assembly 84″ is not required to secure the bolt 104 to the yoke 64″, and thereby to secure the steering shaft assembly to the rack-and-pinion mechanism 46″.

This arrangement is particularly useful to facilitate assembly into the vehicle in light of the confined spaces and lack of access available in the portion of the vehicle containing these components. Specifically, while the first end 86 of the pinion assembly 84″ is difficult to access, the second end 88 of the pinion assembly 84″ is visible and accessible from the underside of the vehicle. The ability to secure the connection between the steering shaft assembly and the rack-and-pinion mechanism from the second end 88 of the pinion assembly 84″ (i.e., from the accessible underside of the vehicle) will reduce assembly time, and therefore assembly cost.

Additionally, this arrangement can provide better axial alignment between the steering shaft assembly and the pinion assembly 84″ than was previously possible using the clamp yoke arrangement described with respect to FIGS. 1-3. Additionally, a reduction in runout can be achieved versus the prior art clamp yoke arrangement.

Those skilled in the art will understand that modifications to the illustrated embodiments can be made without deviating from the invention. Other constructional arrangements in which securement of the steering shaft assembly to the pinion assembly can be achieved from the end of the pinion assembly accessible at the underside of the vehicle (i.e., the second end 88) are also contemplated. For example, while the illustrated fasteners are shown as being conventional nuts or bolts, other fasteners and fastening arrangements can be substituted (e.g. pins, snap rings, etc.). Additional or alternative anti-rotation and centering features at the steering shaft assembly/pinion assembly interface can also be included or substituted. In another embodiment that would be a hybrid of the illustrated embodiments, the shafts 68, 68′ could be somewhat shorter so as not to extend out from the second end 88 of the pinion assembly and could include a threaded internal bore in the end for receiving a bolt that could be inserted from the second end 88 of the pinion assembly.

Various features and advantages of the invention are set forth in the following claims.

What is claimed is:

1. A steering assembly comprising:
a steering shaft assembly having an end;
a rack-and-pinion mechanism including a pinion assembly coupled to the end of the steering shaft assembly, the pinion assembly including a bore extending between a first end of the pinion assembly and a second end of the pinion assembly; and
a fastener securing the end of the steering shaft assembly to the pinion assembly, at least one of the end of the steering shaft assembly and the fastener being at least partially received within the bore in the pinion assembly.

2. The steering assembly of claim 1, wherein the pinion assembly includes a pinion housing and a pinion supported within the pinion housing, the bore in the pinion assembly being formed in the pinion.

3. The steering assembly of claim 1, wherein the end of the steering shaft assembly includes a shaft, the shaft received in the bore of the pinion assembly and extending from the second end of the pinion assembly such that the fastener is secured to the portion of the shaft extending from the second end of the pinion assembly.

4. The steering assembly of claim 3, wherein the shaft has a threaded end and the fastener is a nut secured on the threaded end of the shaft.

5. The steering assembly of claim 3, wherein the shaft is configured to transfer torque to a pinion of the pinion assembly.

6. The steering assembly of claim 3, wherein the shaft is configured to act as a pinion for the rack-and-pinion mechanism such that the pinion assembly does not include any integral pinion.

7. The steering assembly of claim 1, wherein the end of the steering shaft assembly includes a yoke coupled with the first end of the pinion assembly, and wherein the fastener extends through the bore of the pinion assembly and into engagement with the yoke.

8. The steering assembly of claim 7, wherein the fastener is inserted into the bore of the pinion assembly from the second end of the pinion assembly.

9. The steering assembly of claim 7, wherein the yoke includes a threaded portion, and wherein the fastener is a bolt having a threaded end received in the threaded portion of the yoke.

10. The steering assembly of claim 7, wherein at least one of the yoke and the pinion assembly includes an anti-rotation feature at an interface between the yoke and the first end of the pinion assembly.

11. A method of connecting a steering shaft assembly to a pinion assembly of a rack-and-pinion mechanism, the steering shaft assembly having an end and the pinion assembly having a first end for receiving the end of the steering shaft assembly and a second end opposite the first end, the method comprising:
positioning the end of the steering shaft assembly to be received by the first end of the pinion assembly; and
securing the end of the steering shaft assembly relative to the pinion assembly using a fastener that is secured from the second end of the pinion assembly.

12. The method of claim 11, wherein securing the end of the steering shaft assembly using a fastener is achieved without manually securing the end of the steering shaft assembly adjacent the first end of the pinion assembly.

13. The method of claim 11, further comprising:
inserting the end of the steering shaft assembly through a bore extending between the first and second ends of the pinion assembly such that the end of the steering shaft assembly extends out of the pinion assembly adjacent the second end; and
securing a fastener to the end of the steering shaft assembly extending out of the pinion assembly adjacent the second end.

14. The method of claim 13, further comprising inserting the end of the steering shaft assembly through the bore in the pinion assembly until a shoulder of the steering shaft assembly abuts the first end of the pinion assembly.

15. The method of claim 13, wherein the pinion assembly includes a pinion defining the bore, and wherein inserting the end of the steering shaft assembly through the bore provides a torque transferring relation between the end of the steering shaft assembly and the pinion.

16. The method of claim 13, wherein inserting the end of the steering shaft assembly through the bore provides an intermeshing relation between the rack-and-pinion mechanism and the end of the steering shaft assembly such that the end of the steering shaft assembly functions as the pinion of the rack-and-pinion mechanism.

17. The method of claim 11, wherein the end of the steering shaft assembly includes a yoke configured to be received by the first end of the pinion assembly, and wherein securing the end of the steering shaft assembly relative to the pinion assembly includes inserting the fastener into the bore in the pinion assembly from the second end of the pinion assembly and into engagement with the yoke.

18. The method of claim 17, wherein the yoke includes a threaded portion, and wherein the fastener is a bolt having a threaded end received in the threaded portion of the yoke.

19. The method of claim 18, further comprising:
securing the yoke against relative rotation with the pinion assembly.

20. The method of claim 11, wherein the fastener is a threaded fastener, and wherein the threaded fastener is tightened from the second end of the pinion assembly.
